(19) United States
(12) Patent Application Publication
(10) Pub. No.: US 2021/0212878 A1
(43) Pub. Date: Jul. 15, 2021

(54) ANKLE AND TOE FUNCTION TRAINING DEVICE

(71) Applicant: INNOPHYS Co., LTD., Tokyo (JP)

(72) Inventors: Hiroshi KOBAYASHI, Tokyo (JP); Yuuki IKEDA, Tokyo (JP)

(73) Assignee: INNOPHYS Co., LTD., Tokyo (JP)

(21) Appl. No.: 16/967,532

(22) PCT Filed: Jan. 23, 2019
(86) PCT No.: PCT/JP2019/002124

§ 371 Date: Aug. 5, 2020

(30) Foreign Application Priority Data
Feb. 5, 2018 (JP) 2018-018456

(51) Int. Cl. A61H 1/02

(52) U.S. Cl. CPC A61H 1/0266; A61H 2201/1676; A61H 2201/164; A61H 2001/027

(57) ABSTRACT

Provided is an apparatus for functional training of an ankle and toe, which can provide better service results. An apparatus for functional training of an ankle and toe includes a foot platform configured to receive a foot of a user and disposed to face a portion of the foot of the user from rearfoot to forefoot; and an artificial muscle configured to displace the foot platform when operated. The apparatus for functional training of an ankle and toe further includes a toe platform disposed to face a toe of the user when the foot of the user is placed on the foot platform. The toe platform is configured to be displaced with respect to the foot platform when the artificial muscle is operated to displace the foot platform.

### TECHNICAL FIELD

The present invention relates to an apparatus for functional training of the ankle and toe.

### BACKGROUND ART

JP 2017-169684 A discloses an ankle stretching apparatus which operates, while holding the user's foot, to stretch the user's ankle. According to this document, the ankle stretching apparatus includes a foot holder configured to hold the user's foot. The foot holder is tilted by a motor to dorsiflex and plantarflex the user's ankle.

### DISCLOSURE OF THE INVENTION

### Problems to be Solved by the Invention

Training apparatuses for rehabilitation of the user's foot or other body part, such as ankle stretching apparatuses, should provide good service results so that the user's motivation for rehabilitation will not decrease.

In light of the facts mentioned above, an object of the present invention is to provide an ankle and toe training apparatus that can provide better service results.

### Means for Solving the Problems

The present invention is directed to an apparatus for functional training of an ankle and toe, including: a foot platform configured to receive a foot of a user and disposed to face a portion of the foot of the user from rearfoot to forefoot; an actuator configured to displace the foot platform when operated; and a toe platform disposed to face a toe of the user when the foot of the user is placed on the foot platform and configured to be displaced with respect to the foot platform when the actuator is operated to displace the foot platform.

### Effects of the Invention

The ankle and toe training apparatus according to the present invention has an advantageous effect by providing better service results.

### BRIEF DESCRIPTION OF THE DRAWINGS

FIG. 1 is a perspective view of an ankle and toe training apparatus according to an embodiment, as viewed obliquely from the front left top side;

FIG. 2 is a perspective view of the ankle and toe training apparatus according to an embodiment, as viewed obliquely from the rear left bottom side;

FIG. 3 is a plan view of the ankle and toe training apparatus according to an embodiment, as viewed from the top side;

FIG. 4 is a left side view of the ankle and toe training apparatus according to an embodiment, as viewed from the left side;

FIG. 5 is a left side view of an ankle and toe training apparatus with sandals attached thereto according to an embodiment, as viewed from the left side;

FIG. 6 is a side view showing schematically the movement of the foot of the user who uses the ankle and toe training apparatus, in which the user's foot is dorsiflexed;

FIG. 7 is a side view showing schematically the movement of the foot of the user who uses the ankle and toe training apparatus, in which the user's foot is plantarflexed; and

FIG. 8 is a perspective view of an ankle and toe training apparatus according to another embodiment, as viewed obliquely from the rear right top side.

### PREFERRED MODE FOR CARRYING OUT THE INVENTION

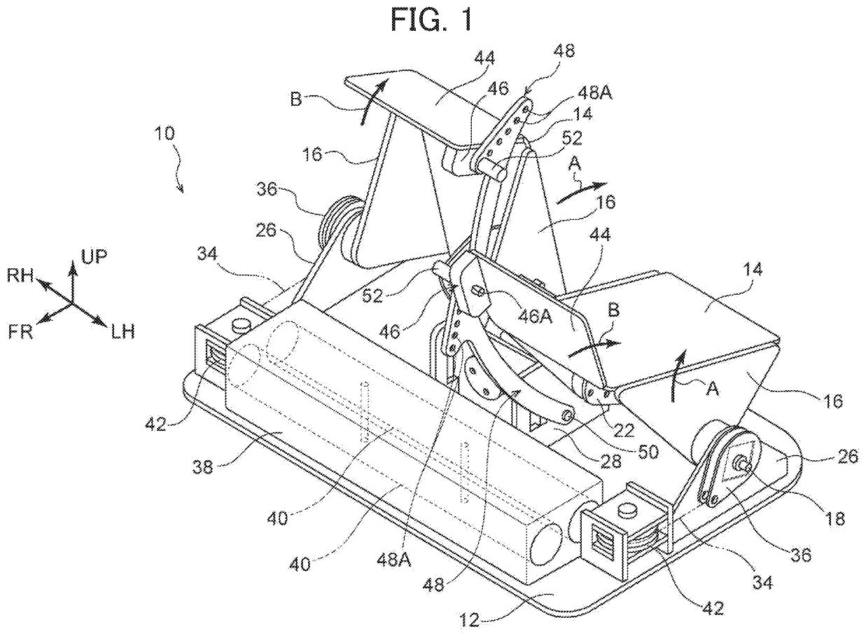

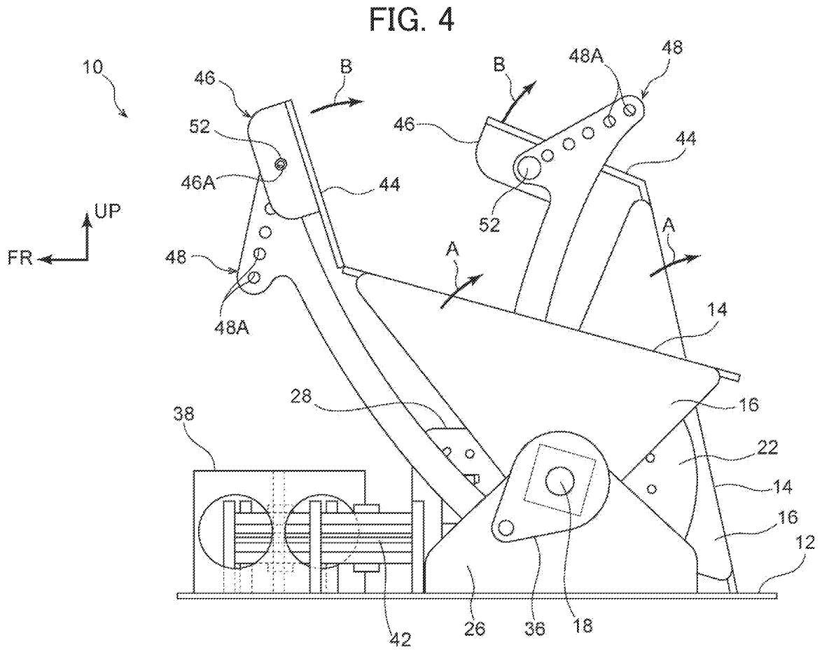

With reference to FIGS. 1 to 5, an ankle and toe training apparatus 10 according to an embodiment of the present invention will be described. With respect to the ankle and toe training apparatus 10, arrows FR, RH, LH, and UP respectively indicate the front side in the front-rear direction, the right side, the left side, and the top side in the top-bottom direction. Hereinafter, the front-rear, left-right, and top-bottom directions of the ankle and toe training apparatus 10 may be simply referred to as the front-rear, left-right, and top-bottom directions.

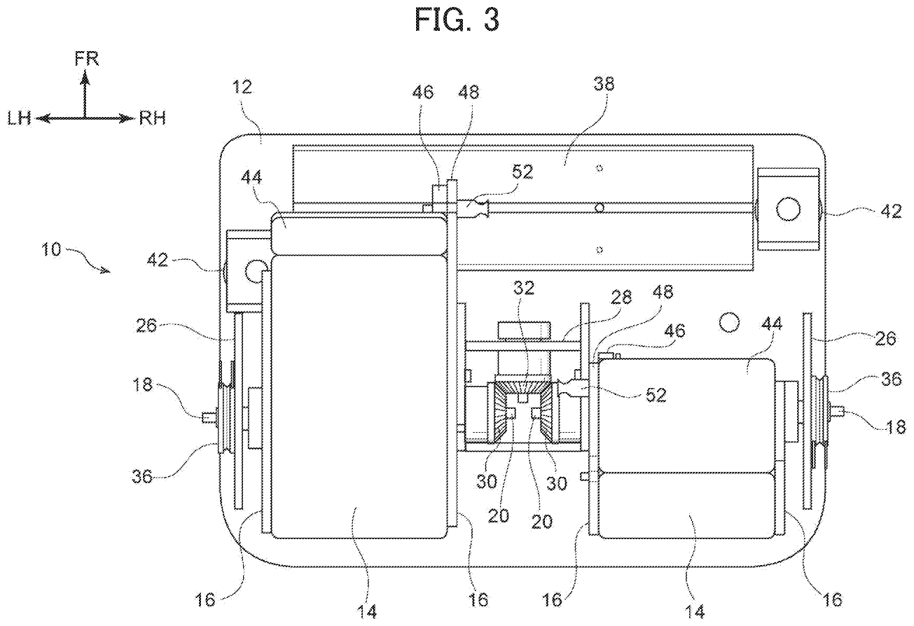

As shown in FIGS. 1 to 4, the ankle and toe training apparatus 10 according to an embodiment is configured to stretch the user's ankles when operated with both feet of the user placed thereon. As shown in FIG. 3, the ankle and toe training apparatus 10 includes a base 12 that is placed on a floor or other surface. The base 12 is a rectangular plate having a longitudinal direction in the left-right direction in plan view (from the top side).

The ankle and toe training apparatus 10 also includes a pair of left and right foot flatforms 14 each configured to receive the user's foot and disposed to face a portion of the user's foot from rearfoot to forefoot. The foot platform 14 is a rectangular plate having a longitudinal direction in the direction from the rearfoot to forefoot of the user's foot. A pair of sidewall plates 16 are fixed to both of the left and right ends of the foot platform 14. The sidewall plates 16 are triangular in side view (as viewed from the left or right side). The left and right sidewall plates 16 extend in parallel with each other with their thickness direction in the left-right direction.

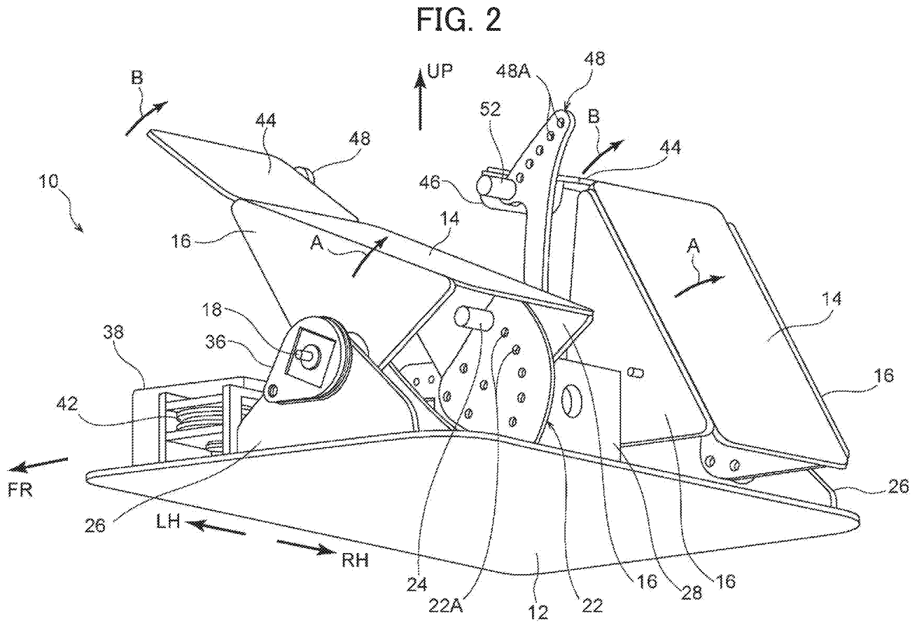

As shown in FIGS. 1 and 2, a rotating shaft 18 having an axial direction in the left-right direction is fixed to the left sidewall plate 16 fixed to the left foot platform 14. As shown in FIG. 3, a rotating shaft 20 having an axial direction in the left-right direction is inserted into the right sidewall plate 16 fixed to the left foot platform 14. As shown in FIGS. 2 and 3, a tilting angle limiting plate 22 is fixed to the rotating shaft 20. The tilting angle limiting plate 22 is substantially fan-shaped in side view and disposed along the right sidewall plate 16 fixed to the left foot platform 14. The tilting angle limiting plate 22 has plural pin receiving holes 22A into one of which a pin 24 is inserted. The right sidewall plate 16 fixed to the left foot platform 14 has a pin receiving hole (not shown) into which the pin 24 is inserted. When the pin 24 is engaged with the tilting angle limiting plate 22 (pin receiving hole 22A) and the right sidewall plate 16 (pin receiving hole not shown) fixed to the left foot platform 14, the tilting angle limiting plate 22 is displaced (tilted) around the rotating shaft 20 as an axis together with the right sidewall plate 16 fixed to the left foot platform 14. When the tilting angle limiting plate 22 comes into contact with the base 12 as a result of the displacement together with the right sidewall plate 16 fixed to the left foot platform 14, the tilting of the left foot platform 14 in the dorsiflexion direction (indicated by the arrow A) is limited. The maximum angle of tilting of the left foot platform 14 in the dorsiflexion direction is adjustable by changing the position at which the pin 24 is inserted into one of the pin receiving holes 22A.

A rotating shaft 18 having an axial direction in the left-right direction is also fixed to the right sidewall plate 16 fixed to the right foot platform 14. A rotating shaft 20 having an axial direction in the left-right direction is also inserted into the left sidewall plate 16 fixed to the right foot platform 14, and a tilting angle limiting plate 22 is fixed to the rotating shaft 20. The relationship between the tilting angle limiting plate 22 and the left sidewall plate 16 fixed to the right foot platform 14 is the same as that described above between the tilting angle limiting plate 22 and the right sidewall plate 16 fixed to the left foot platform 14.

As shown in FIG. 3, the rotating shafts 20 disposed at the left-right directional center of the ankle and toe training apparatus 10 are rotatably supported on a gear box 28, which is described later. The rotating shafts 18 disposed on both of the left-right directional sides of the ankle and toe training apparatus 10 are each rotatably supported on a support plate 26 fixed to the base 12. Therefore, the foot platforms 14 are each tilted (rotated) in the dorsiflexion and plantar flexion directions (top-bottom directions) around the rotating shafts 18 and 20 as axes.

The gear box 28, which is box-shaped, is provided between the left and right foot platforms 14. The gear box 28 is fixed to the base 12. A bevel gear 30 is fixed to each of the two rotating shafts 20 supported on the gear box 28. The bevel gear 30 fixed to one of the rotating shafts 20 is connected to the bevel gear 30 fixed to the other rotating shaft 20 with an interposed bevel gear 32 having an axial direction in the front-rear direction, rotatably supported on the gear box 28. As shown in FIGS. 2 and 3, therefore, when the tilting angle limiting plate 22 is displaceable together with the sidewall plate 16 fixed to the foot platform 14 due to the pin 24 engaged with them, the rotation of one of the rotating shafts 20 is transmitted through the bevel gears 30 and 32 to rotate the other rotating shaft 20 in the reverse direction. Therefore, the left and right foot platforms 14 are tilted in a staggered manner. Specifically, when the right foot platform 14 is tilted upward, the left foot platform 14 is tilted downward, and when the left foot platform 14 is tilted upward, the right foot platform 14 is tilted downward.

When the tilting angle limiting plate 22 is unconnected to the sidewall plate 16 fixed to the foot platform 14 (with the pin 24 detached), the rotation of one of the rotating shafts 20 is not transmitted to the other rotating shaft 20 through the bevel gears 30 and 32. In this case, the left and right foot platforms 14 can be each independently tilted.

As shown in FIGS. 1 and 3, a pulley 36 is fixed to each of the two rotating shafts 18 supported on the left and right support plates 26. A wire 34 is put on each pulley 36. As an artificial muscle 40, described later, contracts, the wire 34 is pulled to rotate the pulley 36. On the side where the wire 34 is pulled, therefore, the foot platform 14 is tilted in the dorsiflexion direction (indicated by the arrow A). It should be noted that the wire 34 is not shown in the drawings other than FIG. 1.

An artificial muscle supporting box 38 is fixed to a front-end portion of the base 12. The box 38 is shaped in a box having a longitudinal direction in the left-right direction. Inside the artificial muscle supporting box 38, two artificial muscles 40 serving as actuators are disposed in parallel with each other in the left-right direction. In this case, the artificial muscles 40 according to an embodiment are what are called McKibben artificial muscles. The artificial muscles 40 each include an elastic tube made of a tube-shaped elastic material such as tube-shaped rubber; and a tubular mesh sleeve that covers the elastic tube, in which the elastic tube covered with the mesh sleeve has both ends swaged. Gas (air) is supplied into the elastic tube to contract the artificial muscle 40 in the left-right direction.

The rear side one of the two artificial muscles 40 has a right end fixed to the artificial muscle supporting box 38 and has a left end connected to the left pulley 36 through the wire 34. The front side one of the two artificial muscles 40 has a left end fixed to the artificial muscle supporting box 38 and has a right end connected to the right pulley 36 through the wire 34. An intermediate portion of the wire 34 between the artificial muscle 40 and the pulley 36 is guided and bent in an L-shape by a guide pulley 42 having an axial direction in the top-bottom direction, rotatably supported on the base 12.

As shown in FIG. 1, a toe platform 44 is attached to the front end of each of the left and right foot platforms 14. The toe platform 44 is plate-shaped like the foot platform 14 and disposed to face the user's toe. The toe platform 44 is attached via a hinge (not shown) to the foot platform 14 so that the toe platform 44 can be tilted in the top-bottom direction around an axis in the left-right direction with respect to the foot platform 14.

On the central side, a link engaging part 46 is fixed to each of right and left end portions of the left and right toe platforms 44. A toe extending link 48 described later is engaged with each link engaging part 46. The link engaging part 46 has a pin receiving hole 46A into which a pin 52, described later, is inserted. It should be noted that the link engaging part 46 is part of the toe platform 44. Alternatively, the toe platform 44 and the link engaging part 46 may be integrally formed. The left link engaging part 46 is connected to the gear box 28 via the toe extending link 48 as a connecting member, and the right link engaging part 46 is connected to the gear box 28 via the toe extending link 48.

The toe extending link 48 is in the form of a plate having a thickness direction in the left-right direction. The toe extending link 48 has one end supported with a pin 50 on the gear box 28 in such a way that it can be tilted (rotated) around an axis in the left-right direction. The toe extending link 48 has the other end in a substantially T-shape. The other end of the toe extending link 48 has plural pin receiving holes 48A. A pin 52 is inserted into one of the pin receiving holes 48A of the toe extending link 46 and into the pin receiving hole 46A of the link engaging part 46, so that the other end of the toe extending link 48 is engaged with the link engaging part 46. When the foot platform 14 is tilted in the plantar flexion direction (reverse to the direction indicated by the arrow A), the toe extending link 48 allows the toe platform 44 to be inclined in the extension direction (indicated by the arrow B) with respect to the foot platform 14. Further, when the foot platform 14 is tilted in the dorsiflexion direction (indicated by the arrow A), the toe extending link 48 allows the toe platform 44 to be inclined in the flexion direction (reverse to the direction indicated by the arrow B) with respect to the foot platform 14. In this embodiment, the position at which the pin 52 is inserted into one of the plural pin receiving holes 48A of the toe extending link 48 can be changed so that the angle at which the toe platform 44 is inclined with respect to the foot platform 14 being tilted can be adjusted.

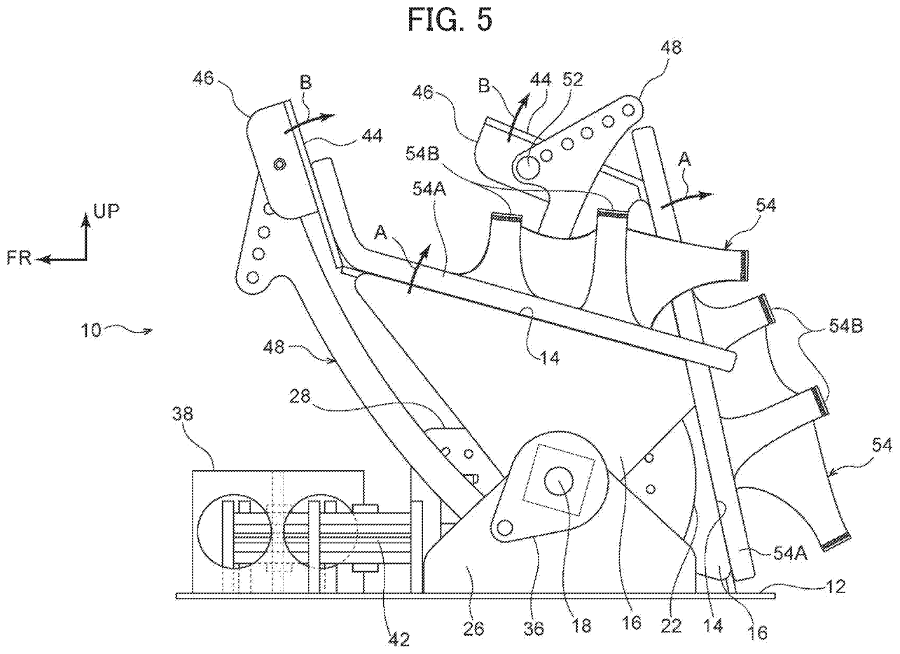

As shown in FIG. 5, the ankle and toe training apparatus 10 according to an embodiment may have holding members 54 each fixed to the foot platform 14. Each holding member 54 is configured to hold the user's foot on the foot platform 14. The holding member 54 includes a bottom portion 54A, a belt 54B, and other components. The bottom portion 54A is disposed along the foot platform 14 and the toe platform 44 and configured to stop the user's heel. The belt 54B is configured to be put around the user's ankle or the like. The holding members 54 may be commercially available sandals or other products.

### Functions and Advantageous Effects of the Embodiment

Next, functions and advantageous effects of the embodiment will be described.

During the operation of the ankle and toe training apparatus 10 according to the embodiment, as shown in FIG. 2, the sidewall plate 16 fixed to the foot platform 14 may be displaced together with the tilting angle limiting plate 22 with the pin 24 connecting them. First, functions and advantageous effects in this case will be described.

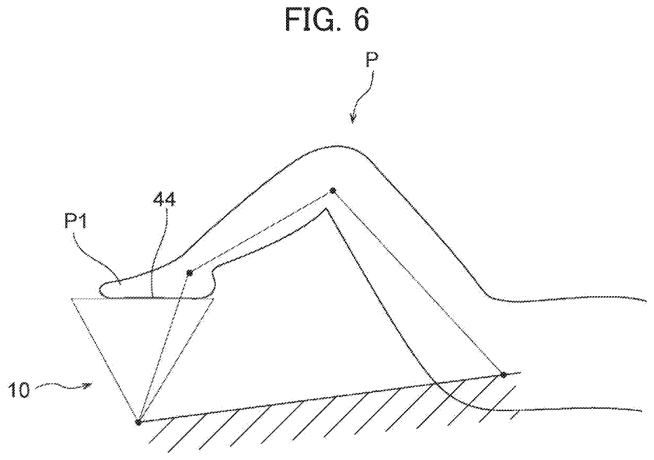

As shown in FIGS. 1 and 5, when the front side one of the two artificial muscles 40 is contracted for the use's foot held with the holding member 54, the right foot platform 14 is tilted in the dorsiflexion direction (indicated by the arrow A) and the right toe platform 44 is inclined in the flexion direction (reverse to the direction indicated by the arrow B) with respect to the foot platform 14. In synchronization with this, the right foot platform 14 is tilted in the plantar flexion direction (reverse to the direction indicated by the arrow A) and the toe platform 44 is inclined in the extension direction (indicated by the arrow B) with respect to the foot platform 14. As shown in FIG. 6, therefore, the user's left foot P1 is plantarflexed while the user's left toe is extended. It should be noted that FIG. 6 does not specifically show the extension of the toe of the left foot P1. Further, the user's right foot is dorsiflexed.

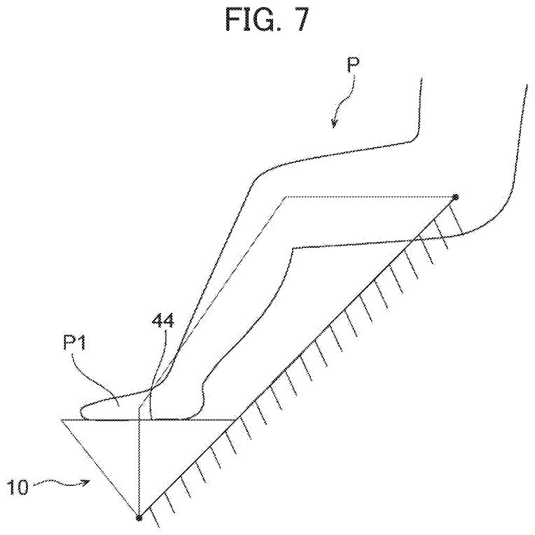

When the rear side one of the two artificial muscles 40 is contracted, the left foot platform 14 is tilted in the dorsiflexion direction (indicated by the arrow A) and the left toe platform 44 is inclined in the flexion direction (reverse to the direction indicated by the arrow B) with respect to the foot platform 14. In synchronization with this, the right foot platform 14 is tilted in the plantar flexion direction (reverse to the direction indicated by the arrow A) and the right toe platform 44 is inclined in the extension direction (indicated by the arrow B) with respect to the foot platform 14. Therefore, the user's right foot is plantarflexed. In addition, as shown in FIG. 7, the user's left foot P1 is dorsiflexed.

When the two artificial muscles 40 are alternately contracted, the left and right foot platforms 14 and the left and right toe platforms 44 are alternately moved as described above. This allows the user's lower extremities P to move like real walking (in a way to mimic the four-joint rotation link).

As described above, according to the embodiment, the ankle and toe training apparatus 10 can provide better service results by extending the toes. In particular, the apparatus 10 is effective in rehabilitation for walking since it allows the user's lower extremities P to move like real walking, which is accompanied by extension of the toes. In addition, if the user suffers from bent ankles, the user can press the heels against the bottom portions 54A of the holding members 54 and use the ankle and toe training apparatus 10 to effectively carry out rehabilitation for walking.

In the embodiment, the position at which the pin 52 is inserted into one of the plural pin receiving holes 48A of the toe extending link 48 can be changed so that the angle at which the toe platform 44 is inclined with respect to the foot platform 14 being tilted can be adjusted. This allows easy adjustment of the load for the extension of the toe.

Further, in the embodiment, the position at which the pin 24 is inserted into one of the plural pin receiving holes 22A of the tilting angle limiting plate 22 shown in FIG. 2 can be changed so that the maximum angle at which the foot platform 14 is tilted in the dorsiflexion direction can be adjusted. This allows easy adjustment of the load for the dorsiflexion of the foot.

During the operation of the ankle and toe training apparatus 10 according to the embodiment, the sidewall plate 16 fixed to the foot platform 14 may not be displaced together with the tilting angle limiting plate 22 with the pin 24 detached from them. Next, functions and advantageous effects in this case will be described.

In this case, when the rear side one of the two artificial muscles 40 is contracted, the left foot platform 14 is tilted in the dorsiflexion direction (indicated by the arrow A) and the left toe platform 44 is inclined in the flexion direction (reverse to the direction indicated by the arrow B) with respect to the foot platform 14. At this time, the right foot platform 14 and the right toe platform 44 are not tilted.

When the front side one of the two artificial muscles 40 is contracted, the right foot platform 14 is tilted in the dorsiflexion direction (indicated by the arrow A) and the right toe platform 44 is inclined in the flexion direction (reverse to the direction indicated by the arrow B) with respect to the foot platform 14. At this time, the left foot platform 14 and the left toe platform 44 are not tilted.

Moreover, when the two artificial muscles 40 are simultaneously contracted, the left and right foot platforms 14 are simultaneously tilted in the dorsiflexion direction (indicated by the arrow A) and the left and right toe platforms 44 are simultaneously inclined in the flexion direction (reverse to the direction indicated by the arrow B) with respect to the foot platforms 14.

When the pin 24 is detached, therefore, the user's left and right feet can be each independently trained as desired.

In the embodiment, the artificial muscles 40 are each adopted as an actuator for tilting the foot platform 14 and the toe platform 44. Therefore, the gas contained in each artificial muscle 40 can reduce the impact from the foot platform 14 onto the user's foot.

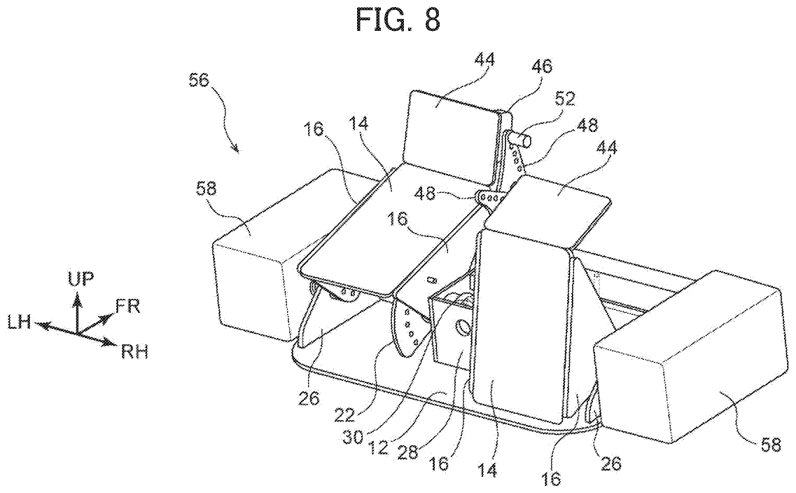

In addition, the artificial muscle 40 is an actuator with a relatively high output per unit mass and unit volume, which makes it possible to make the ankle and toe training apparatus 10 compact and light-weight. FIG. 8 shows an ankle and toe training apparatus 56 according to another embodiment of the present invention, which includes motors 58 as actuators. The ankle and toe training apparatus 56 works with the same level of force to tilt the foot platforms 14 and the toe platforms 44 as that in the ankle and toe training apparatus 10 described above. However, the size of the ankle and toe training apparatus 56 (in particular, the size in the left-right direction) is apparently larger than that of the ankle and toe training apparatus 10 described above. The mass of the ankle and toe training apparatus 56 is also larger than that of the ankle and toe training apparatus 10 described above. The type of the actuator for tilting the foot platform 14 and the toe platform 44 may be selected as desired in consideration of the service conditions for the ankle and toe training apparatus and other factors.

While embodiments of the present invention have been described, it will be understood that the embodiments are not intended to limit the present invention and may be altered or modified various ways without departing from the gist of the present invention.

1. An apparatus for functional training of an ankle and toe, comprising:
a foot platform configured to receive a foot of a user and disposed to face a portion of the foot of the user from rearfoot to forefoot;
an actuator configured to displace the foot platform when operated; and
a toe platform disposed to face a toe of the user when the foot of the user is placed on the foot platform and configured to be displaced with respect to the foot platform when the actuator is operated to displace the foot platform.

2. The apparatus for functional training of an ankle and toe according to claim 1, wherein when the foot platform is displaced in a direction in which the foot of the user is plantarflexed, the toe platform is displaced in a direction in which the toe of the user is extended with respect to the foot platform.

3. The apparatus for functional training of an ankle and toe according to claim 1, which comprises a pair of left and right foot platforms and a pair of left and right toe platforms,
the left and right foot platforms are alternately displaced by the actuator being operated.

4. The apparatus for functional training of an ankle and toe according to claim 1, wherein the foot platform is supported on a base,
a connecting member is provided between the toe platform and the base, and
the toe platform and the connecting member are configured to be connected at different positions to adjust an amount of displacement of the toe platform with respect to the foot platform being displaced.

5. The apparatus for functional training of an ankle and toe according to claim 1, wherein the actuator comprises an artificial muscle configured to contract when gas is supplied to an interior of the artificial muscle.

6. The apparatus for functional training of an ankle and toe according to claim 1, further comprising a holding member that is fixed to the foot platform to stop a heel of the user.
